(19) United States
(12) Patent Application Publication
(10) Pub. No.: US 2018/0024026 A1
(43) Pub. Date: Jan. 25, 2018

(54) System And Method For Integrity Testing Of Flexible Containers

(71) Applicant: EMD Millipore Corporation, Billerica, MA (US)

(72) Inventors: Stephen Proulx, Billerica, MA (US); Jeffrey Pearsons, Billerica, MA (US)

(21) Appl. No.: 15/548,019

(22) PCT Filed: Jan. 12, 2016
(86) PCT No.: PCT/US16/13057

§ 371 Date: Aug. 1, 2017

Related U.S. Application Data
(60) Provisional application No. 62/127,520, filed on Mar. 3, 2015.

(51) Int. Cl. G01M 3/32

(52) U.S. Cl. CPC G01M 3/3218; G01M 3/3254

(57) ABSTRACT

A system and method for measuring integrity of flexible containers is disclosed. The system uses a low mass flow transducer to monitor the flow of fluid into the flexible container. Based on this flow rate, the existence of an orifice in the flexible container may be detected. The system also includes a second flow path to the flexible container to allow for faster fill times. Greater flow rates are achieve through the use of a second high mass flow transducer or a calibrated bypass path. These alternate paths allow greater flow rates until the flexible container is determined to be nearly full, at which point all flow passes with the low mass flow transducer.

This application claims priority of U.S. Provisional Application Ser. No. 62/127,520 filed Mar. 3, 2015, the disclosure of which is incorporated herein by reference.

### BACKGROUND

Integrity testing provides a mechanism to determine whether an article has any defects that allow the unwanted passage of particles or other materials. Integrity testing is widely performed on filter elements. In some embodiments, the filter element is wetted and is subjected to a fluid at a predetermined pressure at its inlet side. The pressure is then measured at the outlet side and the differential pressure may be used to determine the integrity of the filter element.

In other embodiments, pressure decay is used to determine the integrity of the article. For example, a fluid at a predetermined pressure may be supplied to the inlet of the article. As fluid passes through the article, the pressure at the inlet side decreases. The rate of pressure decay may be used to determine whether the rate at which the fluid exits the article is within acceptable limits. In both cases above, the precise volume needs to be known to calculate the actual leak rate. This requires time and is needed for different size/volume devices.

This technique may be used to test the integrity of flexible, preferably closed, containers. In operation, the flexible container is filled with a fluid until a predetermined pressure is reached within the flexible container. The flexible is then sealed and the pressure decay is monitored. The rate at which the pressure decays is indicative of the rate at which the fluid exits the flexible container. Based on this rate, the integrity of the flexible container can be determined.

In another embodiment, the pressure of the external environment is monitored. For example, the flexible container is filled with fluid at a predetermined pressure. The flexible container is then placed in an external environment of known pressure, such as a vacuum chamber. The rise in pressure in the external environment is then monitored to determine the rate at which fluid exits the flexible container. This rise is pressure of the external environment is used to determine the integrity of the flexible container.

These techniques are useful when the volume of the flexible container is relatively small. However, at larger volumes, it becomes impractical to place the flexible container in a sealed external environment.

Further, measuring pressure decay may be futile. The large volume of the flexible container implies that very small pressure decays will be observed, as there is an inverse relationship between volume and pressure change. In addition, the magnitude of this pressure decay may not be accurately measured. One option to increase the magnitude of the pressure decay is to extend the duration of the integrity test. However, this approach lowers throughput and efficiency. Another option is to increase the predetermined pressure of the fluid in the flexible container. However, in many cases, the flexible container may not be able to withstand this higher pressure without stretching or deforming.

Therefore, it would be beneficial if there were a system and method for measuring integrity of larger flexible containers.

### SUMMARY

A system and method for measuring integrity of flexible containers is disclosed. The system uses a low mass flow transducer to monitor the flow of fluid into the flexible container. Based on this flow rate, the existence of an orifice in the flexible container may be detected. The system also includes a second flow path to the flexible container to allow for faster fill times. Greater flow rates are achieve through the use of a second high mass flow transducer or a calibrated bypass path. These alternate paths allow greater flow rates until the flexible container is determined to be nearly full, at which point all flow passes with the low mass flow transducer.

In one embodiment, a system for determining the integrity of a container is disclosed. The system comprises a constant pressure fluid source; a valve having a first outlet and a second outlet; a high mass flow transducer in communication with the first outlet and with the container; a low mass flow transducer in communication with the second outlet and with the container; and a controller, in communication with the valve, the high mass flow transducer and the low mass flow transducer, wherein the controller controls the valve to select the first outlet or the second outlet.

In another embodiment, a system for determining the integrity of a container is disclosed. The system comprises a constant pressure fluid source; a low mass flow transducer in communication with the constant pressure fluid source and with the container; a bypass path comprising a valve, where an input of the valve is in communication with the constant pressure fluid source and an output of the valve is in communication with the container, and where there is a predetermined relationship between a flow rate through the low mass flow transducer and the bypass path when the valve is open; and a controller, in communication with the valve and the low mass flow transducer, wherein the controller controls the valve to allow or stop a flow of fluid through the bypass path.

In another embodiment, a method of determining the integrity of a container is disclosed. The method comprises delivering a fluid having a constant pressure to an inlet of a valve, the valve having a first outlet in communication with a high mass flow transducer and a second outlet in communication with a low mass flow transducer, the high mass flow transducer and the low mass flow transducer in communication with the container; selecting the first outlet so that fluid passes through the high mass flow transducer; monitoring a flow rate through the high mass flow transducer; selecting the second outlet so that fluid passes through the low mass flow transducer when the monitored flow rate through the high mass flow transducer decreases below a predetermined level; monitoring the flow rate through the low mass flow transducer so as to determine the integrity of the container.

In another embodiment, a method of determining the integrity of a container is disclosed. The method comprises delivering a fluid having a constant pressure to an inlet of a valve, the valve having an outlet in with a bypass path in communication with the container and to a low mass flow transducer, in communication with the container; opening the valve so that fluid passes through the bypass path and the low mass flow transducer; monitoring a flow rate through the low mass flow transducer; closing the valve so that fluid only passes through the low mass flow transducer when the monitored flow rate through the low mass flow transducer decreases below a predetermined level; and monitoring the flow rate through the low mass flow transducer so as to determine the integrity of the container. In certain embodiments, there is a known relationship between the flow rate through the bypass path and the flow rate through the low mass flow transducer.

### BRIEF DESCRIPTION OF THE FIGURES

For a better understanding of the present disclosure, reference is made to the accompanying drawings, which are incorporated herein by reference and in which:

FIG. 1 illustrates a first embodiment of a system to determine integrity of a flexible container;

FIG. 2A illustrates a graph representing the filling of a flexible container without any leaks;

FIG. 2B illustrates a graph representing the filling of a flexible container having a small leak;

FIG. 2C illustrates a second graph representing the filling of a flexible container having a small leak;

FIG. 3 illustrates a flowchart for the filling and testing of a flexible container using the system of FIG. 1;

FIG. 4 illustrates a second embodiment of a system to determine integrity of a flexible container; and

FIG. 5 illustrates a flowchart for the filling and testing of a flexible container using the system of FIG. 4.

### DETAILED DESCRIPTION

As described, traditional pressure-based integrity tests have limitations, especially as the volume of the flexible container under test becomes large, such as more than 200 liters.

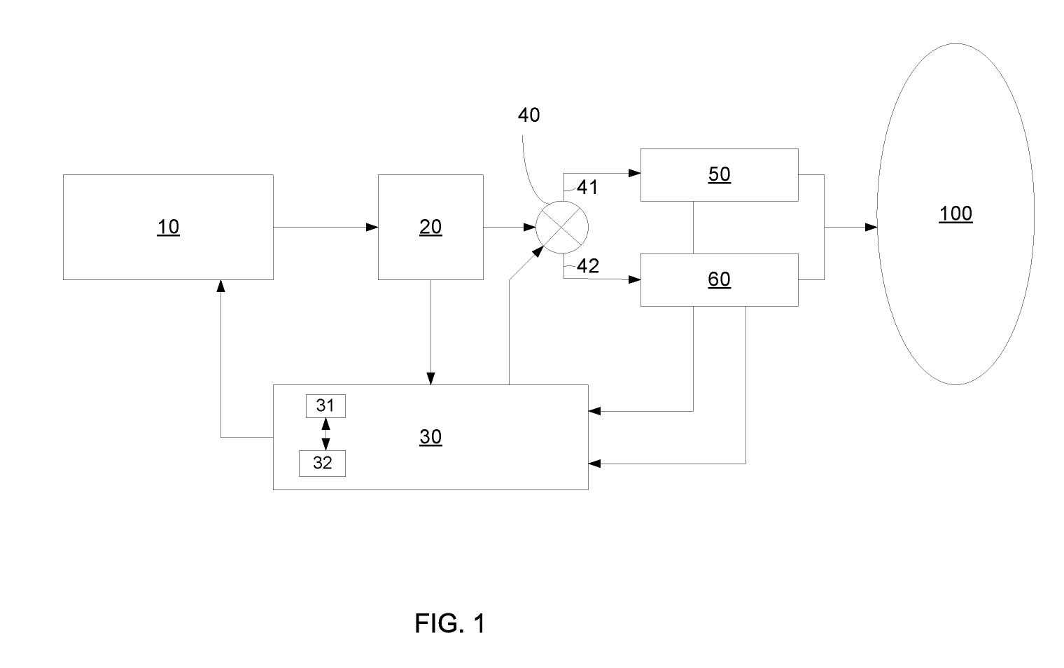

Rather than utilize pressure changes to determine integrity, the present system and method utilizes flow rate to make this determination. FIG. 1 shows a system that may be used to fill the flexible container and also to test its integrity.

In this embodiment, there is a supply of air or another suitable fluid. Typically, the fluid used will be in gaseous form. The fluid supply 10 may be a source of compressed air or may be air passing through a blower, fan or other device. In each embodiment, the fluid supply 10 provides a fluid, such as air, at a variable pressure higher than the pressure of the ambient environment.

The fluid supply 10 is in communication with a transducer 20. This transducer 20 may be a digital pressure transducer, which measures the pressure of the incoming fluid from the fluid supply 10. A controller 30 is in communication with the transducer 20. The controller 30 comprises a processing unit 31 and a storage element 32, in communication with the processing unit 31. The storage element 32 may contain the instructions required for the processing unit 31 to execute the steps and processes described herein. In addition, the storage element 32 may contain other data. The processing unit 31 may be any suitable device, such as a microprocessor, specific purpose controller, computer, or other such device. The storage element 32 may be any non-transitory computer readable media, including a random access memory (RAM) device, a non-volatile memory device, such as a FLASH memory, an electrically erasable ROM, or a storage device, such as a magnetic of semiconductor storage device. As such, the implementation of the processing unit 31 and the storage element 32 are not limited by this disclosure.

The controller 30 monitors the pressure measured by the transducer 20. The controller 30 then adjusts the output of the fluid supply 10 in response to the measurement of the transducer 20. In other words, a constant pressure can be delivered from the transducer 20. The controller 30 operates in a closed loop, reading the pressure from the transducer 20 and adjusting the fluid supply 10 in response to that reading. The fluid supply 10 may be adjusted in a variety of ways. If the fluid supply 10 utilizes a fan or a blower, the pressure of the fluid from the fluid supply 10 may be adjusted by using a variable frequency blower or fan. If the fluid supply 10 utilizes compressed air, an electronic regulator may be adjusted to achieve the desired test pressure.

In all embodiments, the fluid delivered at the output of the transducer 20 may be at the desired test pressure. In some embodiments, the controller 30 is able to control the test pressure delivered from the fluid supply 10 to within 0.1 psi. In some embodiments, the controller 30 is able to control the test pressure delivered from the fluid supply 10 to within about 5% of its setpoint. In some embodiments, the controller 30 determines the temperature of the fluid contained in the fluid supply 10, such as through the use of a temperature sensor. The controller 30 may use information regarding the temperature of the fluid, in conjunction with the flow rate, to determine the size of an orifice in the flexible container.

FIG. 1 shows closed loop control of the fluid pressure through the use of a transducer 20 and a variable fluid supply 10. However, in other embodiments, a constant pressure fluid source may be used. For example, the constant pressure fluid source may include a source of compressed air having a regulator at this output, which finely controls the pressure of the compressed air.

Thus, the fluid supply 10, the transducer 20 and the controller 30 comprise one embodiment of a constant pressure fluid source. Other constant pressure fluid sources may also be used and are within the scope of the disclosure.

The fluid, having a constant pressure, passes the transducer 20 and enters a valve 40. The controller 30 may monitor the temperature of the fluid using a temperature sensor. The valve 40 has an inlet, is electronically controllable and is selectable between at least two different outlets 41, 42. The controller 30 is in communication with the valve 40 and is able to select one of the different outlets 41, 42. The first outlet 41 is in communication with a high mass flow transducer 50, which measures the flow rate of the fluid passing therethrough. The fluid passing through the high mass flow transducer 50 enters the flexible container 100. The high mass flow transducer is capable of measuring large flow rates, such as over 100 standard liters/min (slpm). The second outlet 42 of the valve 40 is in communication with a low mass flow transducer 60. Like the high mass flow transducer 50, the low mass flow transducer 60 is capable of measuring the flow of fluid passing through it as it enters the flexible container 100. However, the low mass flow transducer 60 is designed to accurately measure very small flow rates, such as less than 4 standard cubic centimeters per minute (sccm). Each mass flow transducer has a range of flow rates that it is capable of accurately detecting. In some embodiments, the lower end of the range of the high mass flow transducer 50 is less than the upper end of the low mass flow transducer 60. In this way, all flow rates between the minimum detectable by the low mass flow transducer 60 and the maximum detectable by the high mass flow transducer 50 can be accurately determined.

The flow rate measurements from the high mass flow transducer 50 and the low mass flow transducer 60 are both supplied to the controller 30.

In operation, the controller 30 uses pressure measurements from the transducer 20 to regulate the fluid supply 10 so that a constant fluid pressure is presented to the valve 40. When the flexible container 100 is first attached and is empty, the controller 30 controls the valve 40 so that the first outlet 41 is enabled. In this way, the fluid passes through the high mass flow transducer 50 before entering the flexible container 100. The flow rate of fluid at this time will be high, as there is a large pressure difference between the fluid at the valve 40 and the interior of the flexible container 100. This large pressure difference is due to the fact that the pressure within the flexible container 100 remains nearly zero until the bag is nearly filled. As the flexible container 100 fills with fluid and becomes nearly fully inflated, the pressure difference decreases, and the flow rate through the high mass flow transducer 50 is correspondingly reduced.

When the flow rate drops to a predetermined level, the controller 30 determines that the flexible container 100 is nearly full. This predetermined level may be an absolute flow rate or may be relative to the initial flow rate. For example, the predetermined level may be 5% of the initial flow rate. In another embodiment, the predetermined level is based on the maximum allowable flow rate of the low mass flow transducer 60.

When the controller 30 determines that the flexible container 100 is nearly full, it actuates the valve 40 so that the second outlet 42 is enabled and the first outlet 41 is closed. This causes the fluid to flow through the low mass flow transducer 60, which is able to measure these smaller flow rates.

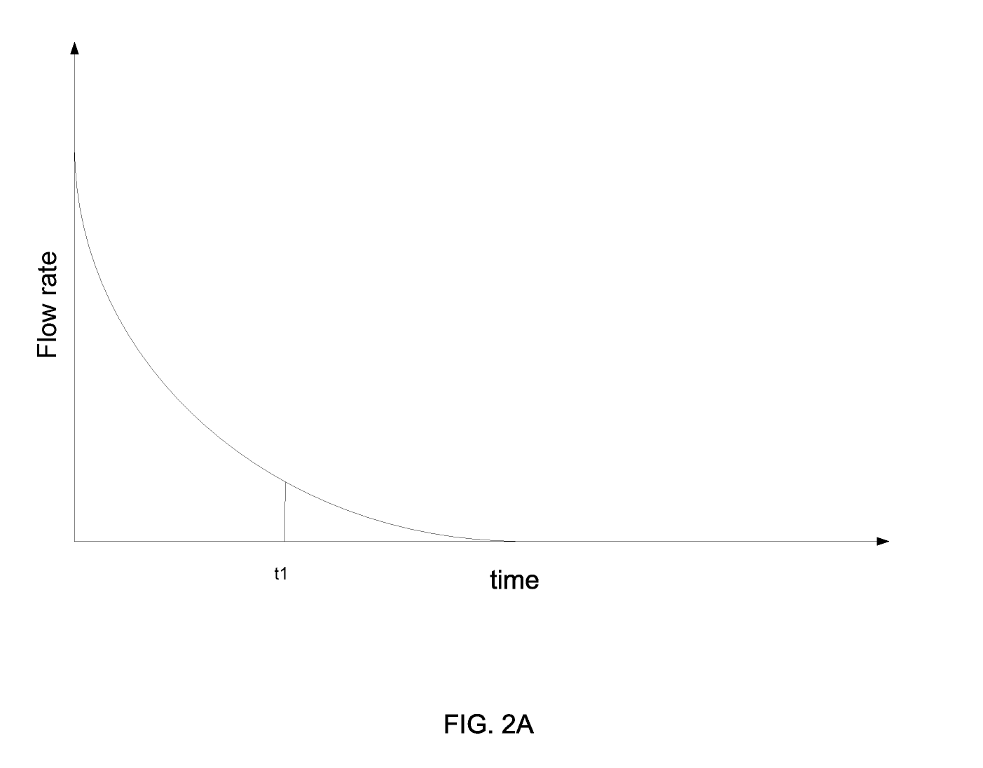

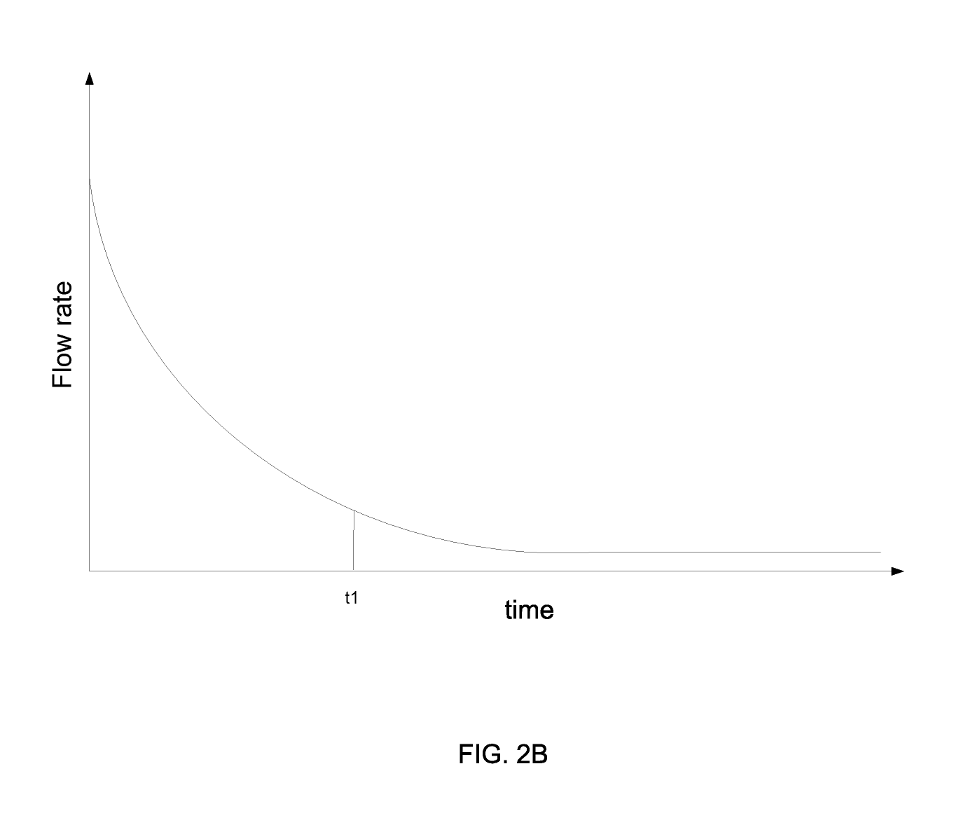

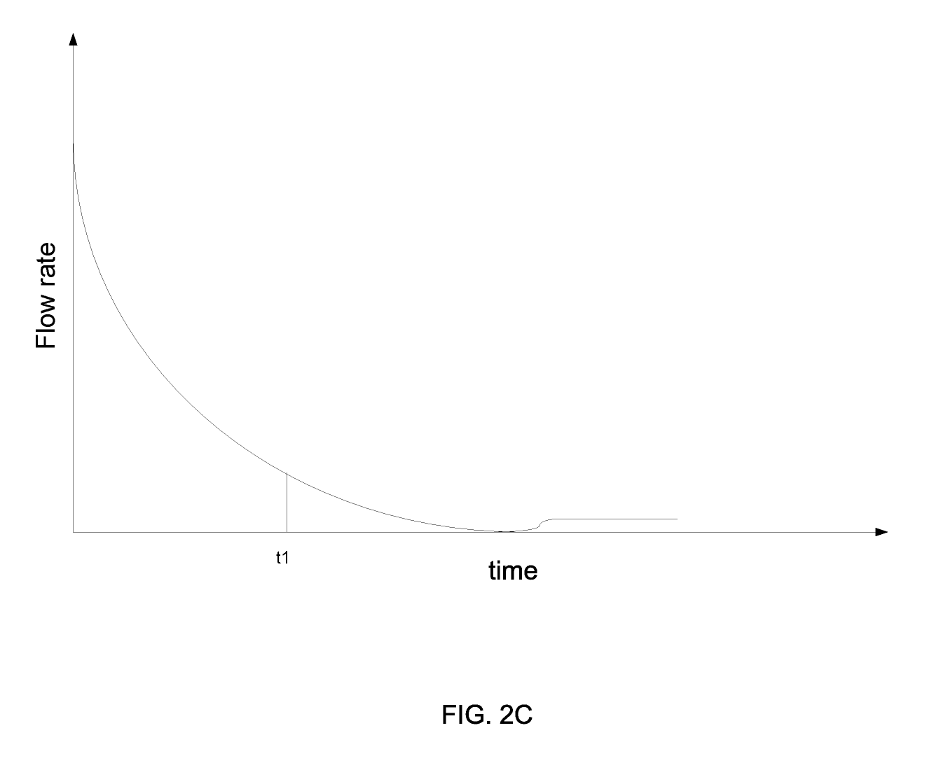

In a flexible container have no leakage, the flow rate through the low mass flow transducer 60 should approach or reach 0. FIG. 2A shows a graph of flow rate vs. time for a flexible container 100 that has no leakage. As explained above, the flow rate starts at a high value and decreases as the flexible container 100 fills. At time t1, the controller 30 determines that the flexible container 100 is nearly full and switches to the second outlet 42 of the valve 40 and disables first outlet 41. Thus, the flow rate measurements taken prior to time t1 as from the high mass flow transducer 50. At some later time, the flow rate through the low mass flow transducer 60 reaches and stays at 0, indicating that the flexible container 100 is integral and there are no leaks. The area under the flow rate curve represents the volume of the flexible container 100.

However, in a flexible container 100 having a leak, the flow rate will not reach 0 and may remain at some non-zero steady state condition. FIG. 2B shows a graph of flow rate vs. time for a flexible container 100 that has leakage. As explained above, the flow rate starts at a high value and decreases as the flexible container 100 fills. At time t1, the controller 30 determines that the flexible container 100 is nearly full and switches to the second outlet 42 of the valve 40 and disables first outlet 41. Thus, the flow rate measurements taken prior to time t1 as from the high mass flow transducer 50. However, in this embodiment, the flow rate through the low mass flow transducer 60 never reaches 0. Rather, the flow rate remains at some non-zero value, indicating that the flexible container 100 is not integral and there is a leak.

FIG. 2C shows another graph of flow rate vs. time for a flexible container 100 that has leakage. In this embodiment, the flow rate does reach 0 for some period of time. However, due to the pressure in the flexible container 100, fluid begins leaking, which causes the fluid to begin flowing through the low mass flow transducer 60 again.

Note that FIGS. 2B and 2C both show non-zero steady state values. This steady state value represents the actual leak rate of the flexible container 100. Advantageously, this leak rate is independent of the volume of the flexible container 100, and only reflects the size of the defect. Based on this leak rate, and optionally based on the temperature of the fluid, it is possible to determine the size of the defect in the flexible container 100.

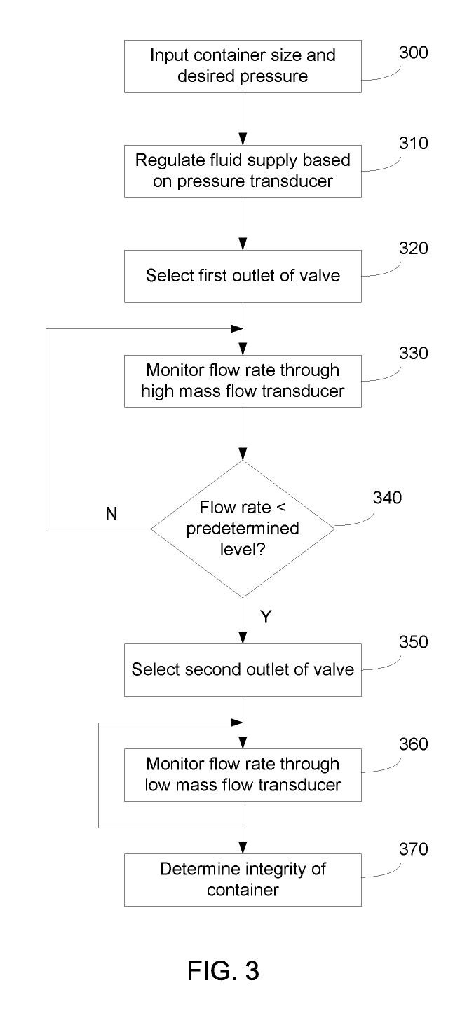

FIG. 3 shows a flowchart illustrating the process of filling and determining the integrity of a flexible container 100. First, as shown in step 300, the volume of the flexible container 100 is supplied to the controller 30. In some embodiments, the controller 30 determines the desired fluid pressure based on the volume of the flexible container 100. In other embodiments, the desired fluid pressure is also provided to the controller 30. In some embodiments, the container volume is not supplied to the controller 30. Rather, the controller 30 executes a universal filling and integrity test, which does not rely on knowing the volume of the flexible container 100 under test. In certain embodiments, the desired pressure is set to a fixed value, which is deemed to be acceptable for a wide range of flexible container volumes.

Based on the desired fluid pressure, the controller 30 regulates the fluid supply 10 based on readings from the transducer 20, as shown in step 310.

The controller 30 then actuates the valve 40 so that the first outlet 41 of the valve 40 is selected, as shown in step 320. This causes the fluid from the fluid supply 10 to pass through the high mass flow transducer 50.

The controller 30 then monitors the flow rate going into the flexible container 100 by querying the high mass flow transducer 50, as shown in step 330. While the flexible container 100 is relatively empty, the flow rate will be high, but will decrease as the flexible container 100 fills, as shown in FIGS. 2A-C. The flow rate measured by the high mass flow transducer 50 is compared to a predetermined level, such as 30L/min, by the controller 30, as shown in step 340. As described above, the predetermined level may be an absolute flow rate, such as a flow rate below the maximum flow rate that can be measured by the low mass flow transducer 60. In other embodiments, the predetermined level may be a percentage of the initial flow rate detected by the high mass flow transducer 50. If the flow rate is still greater than the predetermined level, the controller 30 continues monitoring the flow rate measured by the high mass flow transducer 50, as shown in step 330.

If the flow rate is less than the predetermined level, the controller 30 actuates the valve 40 to select the second outlet 42, as shown in step 350. This allows fluid to flow through the low mass flow transducer 60 and disables flow through the first outlet 41. The controller 30 then monitors the flow rate by querying the low mass flow transducer 60, as shown in step 360.

The controller 30 then determines the integrity of the flexible container 100, as shown in step 370. In some embodiments, integrity is determined by monitoring the flow rate a certain amount of time after the transition to the low mass flow transducer 60. In this way, it is assumed that, if the flexible container 100 were integral, the flow rate would be below some lower threshold at this time. Further, the flow rate at a given pressure and temperature may be correlated to an orifice opening. For example, it may be determined that a 50 micron size hole has a specific leak rate at 0.5 psi. Similarly, other sized orifices may also have specific leak rates at predetermined pressures and temperatures. Thus, based on the pressure, the temperature of the fluid and the final flow rate, the size of the defect (or orifice) may be determined.

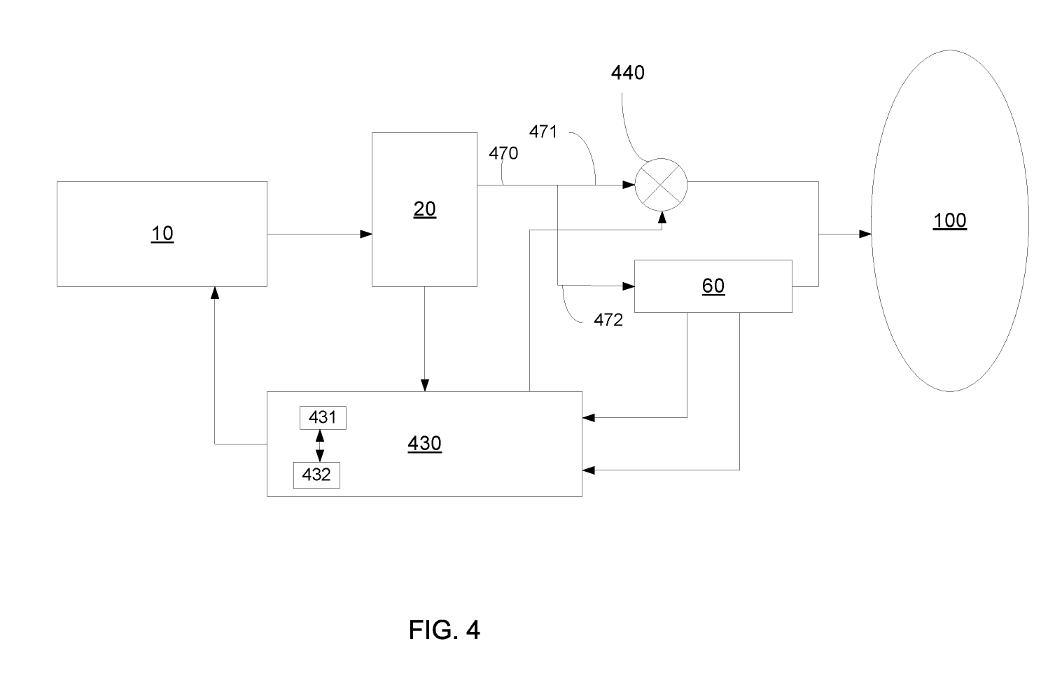

FIG. 4 shows a second embodiment of a system that can be used as a universal test platform. In this figure, some of the components are the same as those shown in FIG. 1 and have been given the same reference designators.

As described with respect to FIG. 1, the fluid supply 10 is in communication with a transducer 20. This transducer 20 may be a digital pressure transducer or any suitable device to measure pressure. The transducer 20 measures the pressure of the incoming fluid from the fluid supply 10. A controller 430 is in communication with the transducer 20. The controller 430 comprises a processing unit 431 and a storage element 432, in communication with the processing unit 431. The storage element 432 may contain the instructions required for the processing unit 431 to execute the steps and processes described herein. In addition, the storage element 432 may contain other data. The processing unit 431 may be any suitable device, such as a microprocessor, specific purpose controller, computer, or other such device. The storage element 432 may be any non-transitory computer readable media, including a random access memory (RAM) device, a non-volatile memory device, such as a FLASH memory, an electrically erasable ROM, or a storage device, such as a magnetic of semiconductor storage device. As such, the implementation of the processing unit 431 and the storage element 432 are not limited by this disclosure.

The controller 430 monitors the pressure measured by the transducer 20. The controller 430 then adjusts the output of the fluid supply 10 in response to the measurement of the transducer 20. In other words, a constant pressure can be delivered from the transducer 20. The controller 30 operates in a closed loop, reading the pressure from the transducer 20 and adjusting the fluid supply 10 in response to that reading. The fluid supply 10 may be adjusted in a variety of ways. If the fluid supply 10 utilizes a fan or a blower, the pressure of the fluid from the fluid supply 10 may be adjusted by using a variable frequency blower or fan. Is the fluid supply 10 utilizes compressed air, an electronic regulator may be adjusted to achieve the desired test pressure.

In all embodiments, the fluid delivered at the output of the transducer 20 may be at the desired test pressure. In some embodiments, the controller 430 is able to control the test pressure delivered from the fluid supply 10 to within 0.1 psi. In some embodiments, the controller 430 is able to control the test pressure delivered from the fluid supply 10 to within about 5% of its setpoint. As stated above, the controller 430 may monitor the temperature of the fluid from the fluid supply 10.

Like FIG. 1, FIG. 4 shows closed loop control of the fluid pressure through the use of a transducer 20 and a variable fluid supply 10. However, in other embodiments, a constant pressure fluid source may be used. For example, the constant pressure fluid source may include a source of compressed air having a regulator at this output which finely controls the pressure of the compressed air.

Thus, the fluid supply 10, the transducer 20 and the controller 430 comprise one embodiment of a constant pressure fluid source. Other constant pressure fluid sources may also be used and are within the scope of the disclosure.

The fluid, having a constant pressure, passes the transducer 20 and enters a conduit 470. This conduit 470 has two branches or paths 471, 472. The first path, or bypass path 471, is in communication with the input to a valve 440, which may be actuated so as to pass fluid through it, or actuated to stop the flow of fluid. The output of the valve 440 is in communication with the flexible container 100.

The second path, or measurement path 472, is in communication with a low mass flow transducer 60. The low mass flow transducer 60 is capable of measuring the flow of fluid passing through it as it enters the flexible container 100. However, the low mass flow transducer 60 is designed to accurately measure very small flow rates, such as less than 4 standard cubic centimeters per minute (sccm).

Further, the size of the conduits used for the bypass path 471 and the measurement path 472 are selected such that there is a known relationship between the flow rate through these two paths 471, 472. For example, the bypass path 471 may be sized such that 99% of all of the fluid passes through the bypass path 471. Of course, other ratios are also within the scope of the disclosure and the system is not limited to any particular ratio. Since there is a known relationship between the flow rate through the bypass path 471 and the flow rate through the low mass flow transducer 60, it is possible to determine the entire flow rate into the flexible container 100, using only the low mass flow transducer 60. For example, in the above example, the flow rate measured by the low mass flow transducer 60 may be multiplied by 20 to determine the total flow rate into the flexible container 100. In some embodiments, it may not be necessary to accurately determine the flow rate into the flexible container 100 during the filling process. Rather, it is only important to determine when the flow rate has decreased to a level that can be accurately measured by the low mass flow transducer 60.

For example, assume that the low mass flow transducer 60 can accurately measure flow rates less than X sccm. Also assume that the flow rate through the bypass path 471 is M times greater than that through the low mass flow transducer 60. Thus, the total flow rate into the flexible container 100 is approximately (M+1)*F, where F is the flow rate measured by the low mass flow transducer 60. Once the flow rate (F) through the low mass flow transducer 60 drops below X/(M+1), it is known that the total flow rate (through both the low mass flow transducer 60 and the bypass path 471) is less than the maximum value that can be measured by the low mass flow transducer 60. At this point, the valve 440 can be actuated to stop the flow of fluid through the bypass path 471, thereby directing the entire flow of fluid through the low mass flow transducer 60. The flow rate required to finish filling the flexible container 100 can be monitored. Similarly, any leakage can be detected based on any residual flow rate (as shown in FIGS. 2B and 2C).

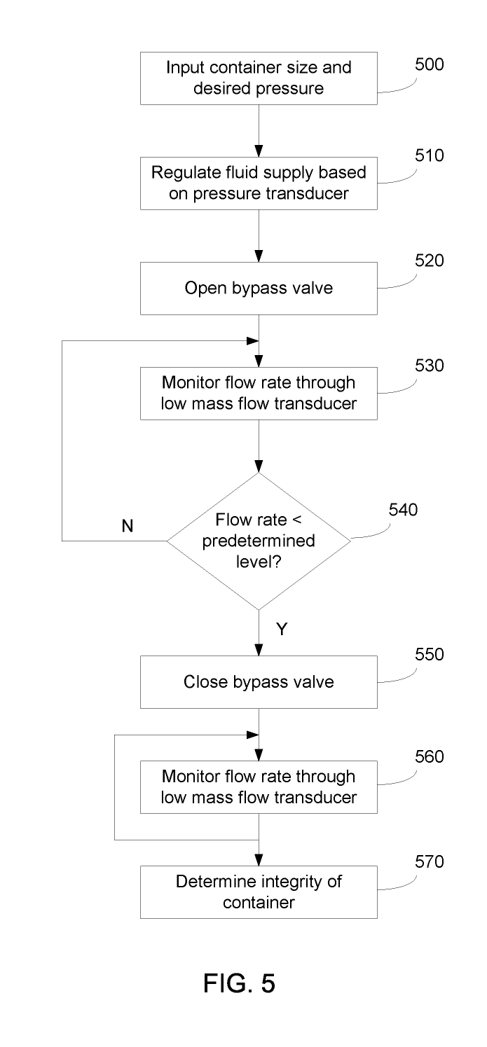

FIG. 5 illustrates a flowchart that may be executed by the controller 430 to operate the system of FIG. 4. First, as shown in step 500, the flexible container volume is supplied to the controller 430. In some embodiments, the controller 430 determines the desired fluid pressure based on the volume of the flexible container 100. In other embodiments, the desired fluid pressure is also provided to the controller 430. In some embodiments, the flexible container volume is not supplied to the controller 430. Rather, the controller 430 executes a universal filling and integrity test, which does not rely on knowing the volume of the container under test. In certain embodiments, the desired pressure is set to a fixed value, which is deemed to be acceptable for a wide range of flexible container volumes.

Based on the desired fluid pressure, the controller 430 regulates the fluid supply 10 based on readings from the transducer 20, as shown in step 510.

The controller 430 then actuates the valve 440 so that the bypass path 471 is opened, as shown in step 320. This causes the fluid from the fluid supply 10 to pass through the bypass path 471 and the low mass flow transducer 60. As described above, in this embodiment the flow rate into the flexible container 100 is (M+1) times the flow rate measured by the low mass flow transducer 60.

The controller 430 then monitors the flow rate going into the flexible container 100 by querying the low mass flow transducer 60, as shown in step 530. While the flexible container 100 is relatively empty, the total flow rate will be high, but will decrease as the flexible container 100 fills, as shown in FIGS. 2A-C. The flow rate measured by the low mass flow transducer 60 is compared to a predetermined level, such as 5 sccm, by the controller 430, as shown in step 540. As described above, the predetermined level may be an absolute flow rate, such as a flow rate below the maximum flow rate that can be measured by the low mass flow transducer 60, divided by (M+1). If the flow rate is still greater than the predetermined level, the controller 430 continues monitoring the flow rate measured by the low mass flow transducer 60, as shown in step 530.

If the flow rate is less than the predetermined level, the controller 430 actuates the valve 440 to disable flow through the bypass path 471, as shown in step 550. This allows all of the fluid to flow through the low mass flow transducer 60. Thus, the flow rate through the low mass flow transducer 60 will increase by a factor of (M+1). The controller 430 then monitors the flow rate by querying the low mass flow transducer 60, as shown in step 560.

The controller 430 then determines the integrity of the flexible container 100, as shown in step 570. In some embodiments, integrity is determined by monitoring the flow rate a certain amount of time after the transition to the low mass flow transducer 60. In this way, it is assumed that, if the flexible container 100 were integral, the flow rate would be below some lower threshold at this time. Further, the flow rate at a given pressure and temperature may be correlated to an orifice opening. For example, it may be determined that a 50 micron size hole has a specific leak rate at 0.5 psi. Similarly, other sized orifices may also have specific leak rates at predetermined pressures and temperatures. Thus, based on the pressure, the fluid temperature and the final flow rate, the size of the defect (or orifice) may be determined.

The disclosed systems and method provide a universal test platform, which can be used for vessels of any size. Because flow rate is used to determine leakage, rather than pressure decay, the system can accommodate any volume container. Further, by employing a fluid supply 10 and a transducer 20, the fluid pressure can be customized based on the volume of the container, thereby optimizing the filling process.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for determining the integrity of a container, comprising:
a constant pressure fluid source;
a valve having a first outlet and a second outlet;
a high mass flow transducer in communication with the first outlet and with the container;
a low mass flow transducer in communication with the second outlet and with the container; and
a controller, in communication with the valve, the high mass flow transducer and the low mass flow transducer, wherein the controller controls the valve to select the first outlet or the second outlet.

2. The system of claim 1, wherein the constant pressure fluid source comprises a variable fluid supply and a pressure transducer, wherein the controller monitors a pressure of the fluid using the pressure transducer and uses the monitored pressure to regulate the variable fluid supply.

3. The system of claim 1, wherein the controller selects the second outlet of the valve when a flow rate of fluid through the high mass flow transducer decreases to below a predetermined level.

4. The system of claim 3, wherein the controller monitors a flow rate through the low mass flow transducer to determine the integrity of the container.

5. A system for determining the integrity of a container, comprising:
a constant pressure fluid source;
a low mass flow transducer in communication with the constant pressure fluid source and with the container;
a bypass path comprising a valve, where an input of the valve is in communication with the constant pressure fluid source and an output of the valve is in communication with the container, and where there is a predetermined relationship between a flow rate through the low mass flow transducer and the bypass path when the valve is open; and
a controller, in communication with the valve and the low mass flow transducer, wherein the controller controls the valve to allow or stop a flow of fluid through the bypass path.

6. The system of claim 5, wherein the constant pressure fluid source comprises a variable fluid supply and a pressure transducer, wherein the controller monitors a pressure of the fluid using the pressure transducer and uses the monitored pressure to regulate the variable fluid supply.

7. The system of claim 5, wherein the controller closes the valve when a flow rate of fluid through the low mass flow transducer decreases to below a predetermined level.

8. The system of claim 7, wherein the controller monitors the flow rate through the low mass flow transducer to determine the integrity of the container.

9. A method of determining the integrity of a container, comprising:
delivering a fluid having a constant pressure to an inlet of a valve, the valve having a first outlet in communication with a high mass flow transducer and a second outlet in communication with a low mass flow transducer, the high mass flow transducer and the low mass flow transducer in communication with the container;
selecting the first outlet so that fluid passes through the high mass flow transducer;
monitoring a flow rate through the high mass flow transducer;
selecting the second outlet so that fluid passes through the low mass flow transducer when the monitored flow rate through the high mass flow transducer decreases below a predetermined level;
monitoring the flow rate through the low mass flow transducer so as to determine the integrity of the container.

10. A method of determining the integrity of a container, comprising:
delivering a fluid having a constant pressure to an inlet of a valve, the valve having an outlet in with a bypass path in communication with the container and to a low mass flow transducer, in communication with the container;
opening the valve so that fluid passes through the bypass path and the low mass flow transducer;
monitoring a flow rate through the low mass flow transducer;
closing the valve so that fluid only passes through the low mass flow transducer when the monitored flow rate through the low mass flow transducer decreases below a predetermined level; and
monitoring the flow rate through the low mass flow transducer so as to determine the integrity of the container.

11. The method of claim 10, wherein there is a known relationship between the flow rate through the bypass path and the flow rate through the low mass flow transducer.
